(19) United States
(12) Patent Application Publication
(10) Pub. No.: US 2022/0229843 A1
(43) Pub. Date: Jul. 21, 2022

(54) FRAMEWORK FOR MODELING HETEROGENEOUS FEATURE SETS

(71) Applicant: salesforce.com, inc., San Francisco, CA (US)

(72) Inventors: Ashish Bharadwaj Srinivasa, San Francisco, CA (US); Jacob Alexander Mannix, Bellevue, WA (US); Mario Sergio Rodriguez, Santa Clara, CA (US)

(21) Appl. No.: 17/154,378

(22) Filed: Jan. 21, 2021

(51) Int. Cl. G06F 16/2457; G06F 16/28

(52) U.S. Cl. CPC G06F 16/24578; G06F 17/16; G06F 16/285

(57) ABSTRACT

Methods, computer readable media, and devices for modeling heterogeneous feature sets for use in personalized search are provided. The method may include generating a similarity factor for each of a plurality of personalization features. For each of the plurality of personalization features, a personalization feature weight is calculated. Each personalization feature weight is converted into a probability distribution and each similarity factor is scaled based on a corresponding probability distribution. Based on each scaled similarity factor, a most recently used affinity value is generated for each corresponding personalization feature. The most recently used affinity values are used to generate a ranking function for use as part of personalized search.

### TECHNICAL FIELD

One or more implementations relate to the field of modeling heterogeneous feature sets; and more specifically, to a framework for modeling heterogeneous feature sets including custom most recently used (MRU) affinity.

### BACKGROUND

A core component of a personalized search experience may involve the use of features called most recently used (MRU) affinity in a ranking model. These MRU affinity features may be defined for each user context and record pair. These MRU affinity features may capture a likelihood or probability of a user clicking on a particular field based on a value contained in that field. For example, a user's 200 most recently viewed records may be used to compute the probability for each record field. MRU affinity features may be easily applied to a standard field that is predefined, such as with a fixed length and/or fixed role. However, MRU affinity features may not be easily applied to a custom field.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description explain the principles of implementations of the disclosed subject matter. No attempt is made to show structural details in more detail than can be necessary for a fundamental understanding of the disclosed subject matter and various ways in which it can be practiced.

FIG. 1A is a block diagram illustrating a system utilizing a framework for modeling heterogeneous feature sets according to some example implementations.

FIG. 1B is a block diagram illustrating a framework for modeling heterogeneous feature sets according to some example implementations.

FIG. 2A is a flow diagram illustrating a method for use with modeling heterogeneous feature sets according to some example implementations.

FIG. 2B is a flow diagram illustrating a method for use with modeling heterogeneous feature sets according to some example implementations.

FIG. 3A is a block diagram illustrating an electronic device according to some example implementations.

FIG. 3B is a block diagram of a deployment environment according to some example implementations.

### DETAILED DESCRIPTION

Various aspects or features of this disclosure are described with reference to the drawings, wherein like reference numerals are used to refer to like elements throughout. In this specification, numerous details are set forth in order to provide a thorough understanding of this disclosure. It should be understood, however, that certain aspects of disclosure can be practiced without these specific details, or with other methods, components, materials, or the like. In other instances, well-known structures and devices are shown in block diagram form to facilitate describing the subject disclosure.

An information management platform may include, for example, a platform for managing a collection of information. In various examples, an information management platform may be a customer relationship management (CRM) platform. Such CRM platform may be used by a number of different organizations and a number of different users within each organization. In various examples, the information managed may be structured as sets of records with each record including standard fields as well as optional custom fields. For example, a CRM platform may include client records, contact records, product records, and/or other types of records. Further in this example, a client record may include standard fields such as client name, client address, and client contact (which may be a reference to one or more contact records) that are common to all or a number of organizations as well as custom fields that are unique to a single organization (e.g., a conference organizer may want an indicator field indicating whether a client is a conference attendee, a conference sponsor, or a conference participant while a marketer may want a preferred brand field and/or a sales term field).

In various examples, users of an information management platform may want or need to perform searches for records based on one or more fields. For example, a user may want to identify all contacts with a last name that begin with the letter “A” and associated with a particular client. In this example, the search may return a number of contact records based on standard fields of last name and associated client. In another example, a user may want to identify all conference attendees. In this example, the search may return a number of records based on a custom field of conference attendee. To facilitate searches, an information management platform may maintain additional information about the various fields. Such additional information is often referred to as features. In various examples, features of a standard field may be readily identifiable and such features may be readily utilized as part of a search functionality because such features are predetermined and/or otherwise fixed. However, features of a custom field may not be readily identifiable and such custom field features may not be readily utilized as part of a search functionality because such custom field features are not predetermined and/or not otherwise fixed. In order to facilitate custom field features in a personalized search functionality, a similarity factor for each custom field feature may be generated and a feature weight for each custom field feature may be calculated, each feature weight may be converted into a probability distribution and each similarity factor may be scaled based on a corresponding probability distribution, a most recently used (MRU) affinity value may be generated for each corresponding customer field feature based on the corresponding scaled similarity factor, and the MRU affinity values may be used to generate a ranking function for the personalized search functionality.

Implementations of the disclosed subject matter provide methods, computer readable media, and devices for modeling heterogeneous feature sets for use in personalized search. Implementations of the disclosed subject matter generate a similarity factor for each of a plurality of personalization features. For each of the plurality of personalization features, a personalization feature weight is calculated. Each personalization feature weight is converted into a probability distribution and each similarity factor is scaled based on a corresponding probability distribution. Based on each scaled similarity factor, a most recently used affinity value is generated for each corresponding personalization feature. The most recently used affinity values are used to generate a ranking function for use as part of personalized search.

Implementations of the disclosed subject matter generate a categorical embedding vector of a variable number of variably sized elements for each of a plurality of personalization features corresponding to a most recently used affinity, calculate a query-record based attention score that indicates a weight of the corresponding personalization feature for each of the plurality of personalization features, convert each query-record based attention score to a corresponding probability distribution, scale each categorical embedding vector based on the corresponding probability distribution, create a fixed-dimensional personalization feature vector by aggregating the scaled categorical embedding vectors based on the probability distributions, combine the fixed-dimensional personalization feature vector and a fixed-dimensional non-personalization feature vector to produce a fixed-dimensional query-record latent space feature vector, and generate a ranking function based on the fixed-dimensional query-record latent space feature vector. In some implementations, calculating a query-record based attention score for each of the plurality of personalization features may include multiplying the fixed-dimensional non-personalization feature vector by a weight matrix to produce a weighted fixed-dimensional non-personalization feature vector and, for each of the categorical embedding vectors, calculating a dot product of the weighted fixed-dimensional non-personalization feature vector and the categorical embedding vector to produce the corresponding query-record based attention score. In various implementations, the ranking function may be one of pointwise, pairwise, groupwise, and set-wise. In some implementations, converting each query-record based attention score to a corresponding probability distribution may include using a softmax activation function.

In one example, an MRU affinity value may be applied to a custom field by creating an unordered variable length feature containing the MRU affinities for each record containing the custom field. In another example, an MRU affinity value may be applied to a custom field by representing custom MRU affinities in a high dimensional sparse space preserving ordering. In these examples, order may represent the ability to map a custom field to its corresponding MRU affinity value or probability. In both of these examples, either the dimensionality or the individuality (order) of the features may be compromised or otherwise impacted in a negative fashion. Implementations of the disclosed subject matter may allow the dimensionality and the individuality (order) of the features to be preserved by converting a heterogeneous feature set of custom MRU affinity into a fixed-dimensional rich latent space representation.

Traditional approaches to custom MRU affinity may only be utilized within a level 1 (L1) ranker or feature store of an information management platform. In one example, the L1 ranker may be a variant of a simple linear model with a dot product of feature values and associated scalar weights. In this example, the L1 ranker may not be able to handle a variable length heterogeneous feature such as custom MRU affinity directly. Instead, a pre-step may be implemented in which feature functions to aggregate custom MRU affinity values for each record are customized. For example, a sum, a mean, a max, and a min of all custom MRU affinity values may be computed for each record to generate a single scalar value for the custom MRU affinity. However, this may require an offline (training time) implementation and an online (serving time) implementation to remain in sync and any new aggregates used for training may need to be implemented and deployed onto a core app.

From a machine learning point of view, a limitation of these traditional approaches may be that they do not model each custom MRU affinity field individually, but as an aggregate in a single scalar value. That is, the same weight and/or importance for each custom MRU affinity value may be learned. In use, however, certain custom MRU affinity fields may be more important than other custom MRU affinity fields as part of a search functionality of an information management platform. In addition, these traditional approaches may not learn feature interactions between non-personalization features (typically corresponding to standard fields) and personalization features (typically corresponding to custom fields).

Learning richer dense feature representations in a L3 reranking model, typically hosted in a search middle tier (SMT) of the information management platform, may fit neatly into a typical existing ranking pipeline of the information management platform. In one example, a complex deep learning reranking model may only act on the top K results fetched by a feature store and may not pose any significant performance or latency concerns. Further in this example, features from the feature store may be reused and an online ranking system may not be altered in any risky way.

In one example, a user may be interacting with an information management platform. In this example, the information management platform may be a customer relationship management (CRM) platform and the CRM may contain or otherwise include information about clients of a company for which the user works. As the user interacts with the CRM, the user may want to search for clients based on a client's name. While the user may know the name of the client to be searched, it may be helpful for the CRM to also suggest various client names to the user. For example, the CRM may provide a list (e.g., a drop-down list) of the most recently used (MRU) client names from which the user may select in order to form or otherwise initiate the search. In order to determine the list of MRU client names, the CRM may evaluate, for example, a number of features related to the client name field. These features may include, for example, a number of page views, a last accessed timestamp, an indication of last viewed, and/or other information regarding the field. As part of the evaluation, each feature may have a different weight or contribution factor. That is, one feature may be more important while another feature may be less important.

In this example, features related to standard fields may be readily generated and corresponding weights may be readily assigned because the nature of the standard fields is predetermined or otherwise known. However, features related to custom fields may not be as readily generated and corresponding weights may not be readily assigned because the nature of a custom field may not be predetermined. For example, one custom field may have x corresponding features while another custom field may have y corresponding features. In addition, weights among the x features for the one custom field may be assigned differently than weights among the y features for the other custom field. This variability of custom fields and the corresponding features needs to be taken into account in order to improve the user experience.

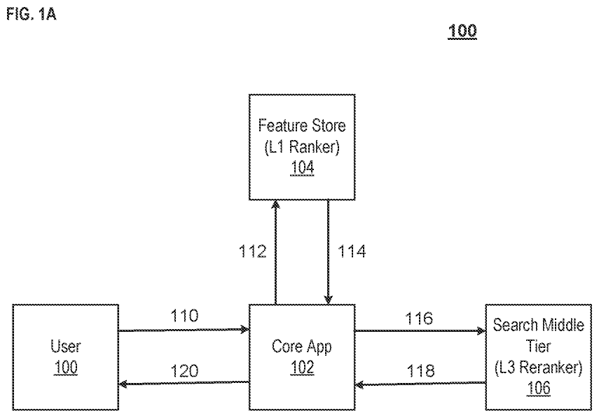

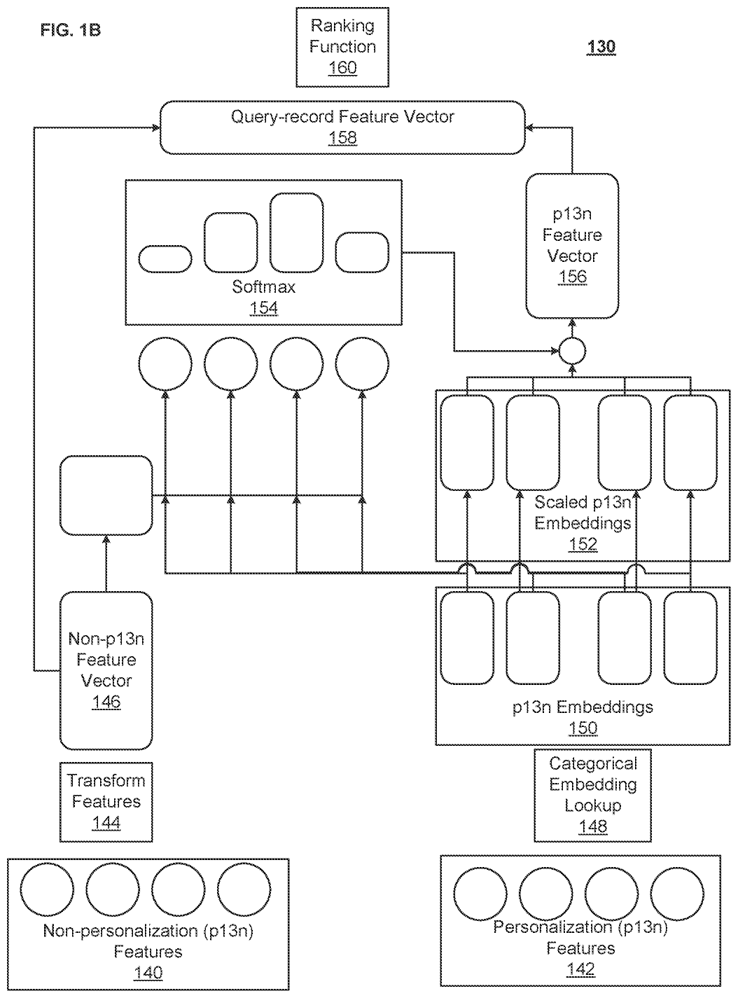

FIG. 1A illustrates a system 100 utilizing a framework for modeling heterogeneous feature sets according to some example implementations. A user 100 may interact with a core application 102. Core application 102 may be, for example, a customer relationship management (CRM) platform, a database management system, and/or some other information management platform. In one example, user 100 may initiate a query 110 based on a field of a record. For example, user 100 may create a search based on a client or customer name, an identifier, an address, or some other field. Core application 102 may, for example, provide a submission 112 to a feature store 104. In various implementations, feature store 104 may be, for example, a collection of information regarding features of various fields used within records of core application 102. For example, the collection of information may include statistics and/or other characteristics related to various fields. Submission 112 may include, for example, a reference to a particular field, such as the field on which a search is based. In response to submission 112, feature store 104 may provide a response 114 to core application 102. In various implementations, response 114 may include, for example, a collection of information regarding features of the particular field referenced in submission 112. That is, submission 112 includes the field to be searched and response 114 includes features of that field.

In various implementations, core application 102 may then provide a search request 116 to search middle tier 106. Search request 116 may include, for example, a reference to the particular field on which the search is based and features of the particular field. In turn, search middle tier 106 may provide, for example, a search response 118 to core application 102 and core application 102 may provide, for example, a query response 120 to user 100. In various implementations, search response 118 and query response 120 may include, for example, one or more records based on query 110 and the corresponding features of the field on which the search is based.

FIG. 1B illustrates a framework 130 for modeling heterogeneous feature sets according to some example implementations. In various implementations, non-personalization features 140 may include, for examples, standard or otherwise readily identifiable features corresponding to a field and personalization features 142 may include, for example, features corresponding to the field and based on a custom nature of the field. Personalization embeddings 150 may be learned, for example, via a categorical embedding lookup 148. In various implementations, personalization embeddings 150 may capture, for example, a contribution of the custom field to a ranking function irrespective of an affinity value corresponding to the custom field. This may facilitate converting each personalization feature from a sparse high dimensional space to a dense latent feature space. This may also facilitate learning a richer feature representation for each field and may implicitly group similar fields closer to each other.

In various implementations, non-personalization features 140 may include, for example, lucene score, page views, query text, organization identifier (ID), and/or other standard features corresponding to a field. Non-personalization features 140 may be transformed, for example, via transform features 144 in order to generate non-personalization feature vector 146. However, non-personalization feature vector 146 may have a different dimension than personalization feature vector 156. In order to address the difference in dimension, non-personalization feature vector 146 may be multiplied, for example, with a weight matrix in order to map non-personalization feature vector 146 into the same dimension as personalization embeddings 150. In turn, a dot product may be generated, for example, for non-personalization feature vector 146 and each personalization embedding vector in order to generate an attention score. In various implementations, attention scores may be, for example, scalar values corresponding to each personalization field used in a model for a given query-record pair. Attention scores may be, for example, converted into a probability distribution using a softmax function or activation layer 154. A softmax function may, for example, normalize an output, such as a neural network output, to a probability distribution over a predicted output class.

In various implementations, personalization embeddings 150 may be scaled, for example, by a factor of a corresponding MRU affinity value to generate scaled personalization embeddings 152. Based on the probability distribution generated by softmax 154, scaled personalization embeddings 152 may be aggregated to generate a fixed dimensional latent space representation for all personalization features which may be conditioned on non-personalization features for a query-record pair. Personalization feature vector 156 and non-personalization feature vector 146 may be combined, for example, to generate query-record feature vector 158. Query-record feature vector 158 may be used, for example, to learn ranking function 160. Ranking function 160 may include, for example, a pointwise ranking function, a pairwise ranking function, a groupwise ranking function, a set-wise ranking function, or some other ranking function.

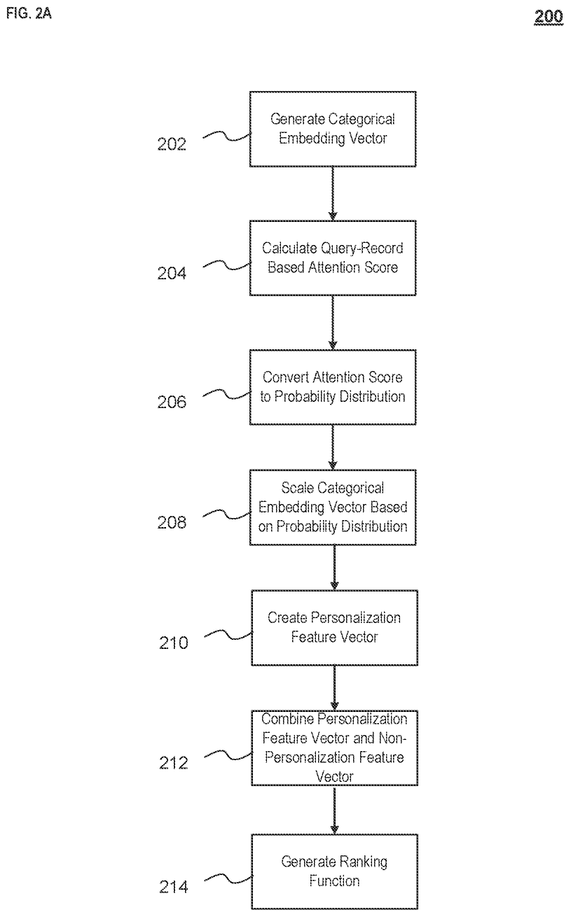

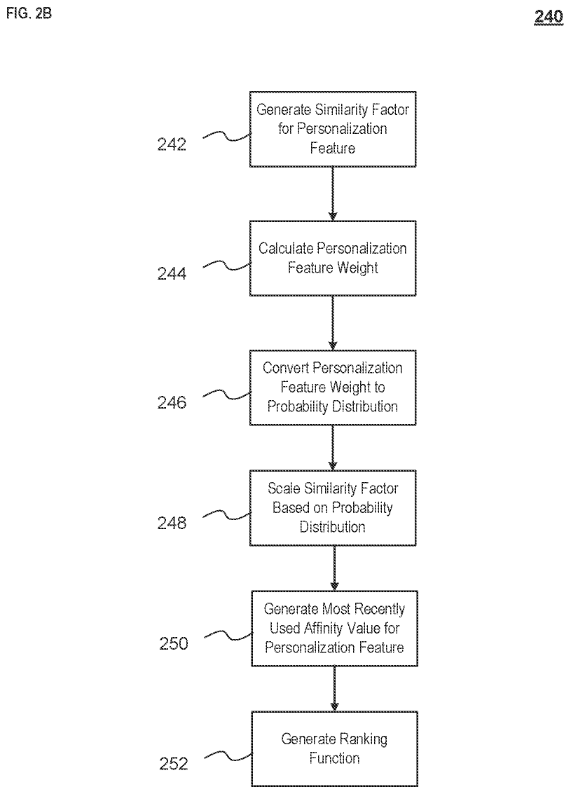

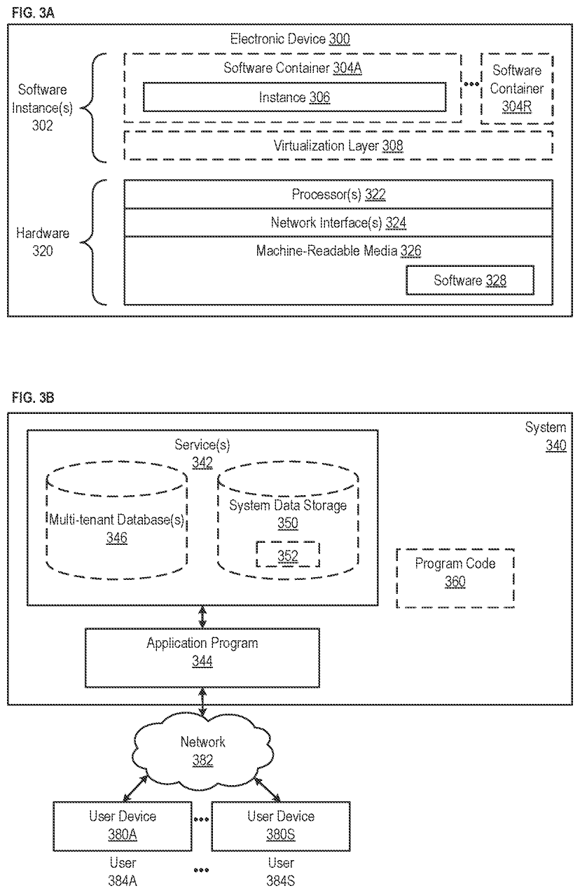

FIG. 2A illustrates a method 200 for use with modeling heterogeneous feature sets, as disclosed herein. The method 200 may be performed as part of an information management platform, such as system 100 of FIG. 1A. In various implementations, the steps of method 200 may be performed by a server, such as electronic device 300 of FIG. 3A or system 340 of FIG. 3B. Alternatively, or in addition, some or all of the steps may be performed by a user device, such as user device 380A of FIG. 3B. Although the steps of method 200 are presented in a particular order, this is only for simplicity.

In step 202, a categorical embedding vector may be generated. For example, a categorical embedding vector may be generated for each of a plurality of personalization features corresponding to a most recently used affinity value. Each categorical embedding vector may include, for example, a variable number of variably sized elements.

In step 204, a query-record based attention score may be calculated, for example, for each of the plurality of personalization features. In various implementations, the query-record based attention score may indicate, for example, a weight of the corresponding personalization feature.

In step 206, each query-record based attention score may be converted, for example, into a corresponding probability distribution.

In step 208, each categorical embedding vector may be scaled, for example, based on a corresponding probability distribution.

A fixed-dimensional personalization feature vector may be created in step 210. For example, the scaled categorical embedding vectors may be aggregated based on the probability distributions to create the fixed-dimensional personalization feature vector.

In step 212, the fixed-dimensional personalization feature vector and a fixed-dimensional non-personalization feature vector may be combined, for example, to produce a fixed-dimensional query-record latent space feature vector.

In step 214, a ranking function may be generated. In various implementations, the ranking function may be generated, for example, based on the fixed-dimensional query-record latent space feature vector. The ranking function may be, for example, a function that reorders a list of input records for a given query. A goal of the ranking function may be, for example, to order records in decreasing order of relevance. In some implementations, relevance may be defined at a per user level (e.g., personalized relevance).

FIG. 2B illustrates a method 240 for use with modeling heterogeneous feature sets, as disclosed herein. The method 240 may be performed as part of an information management platform, such as system 100 of FIG. 1A. In various implementations, the steps of method 240 may be performed by a server, such as electronic device 300 of FIG. 3A or system 340 of FIG. 3B. Alternatively, or in addition, some or all of the steps may be performed by a user device, such as user device 380A of FIG. 3B. Although the steps of method 240 are presented in a particular order, this is only for simplicity.

In step 242, a similarity factor for each of a plurality of personalization features may be generated. In various implementations, the importance of each personalization feature towards relevance of a record in relation to other personalization features (e.g., feature 1 is more indicative of record relevance while feature 2 is less indicative) may be represented by a similarity factor. In these implementations, the similarity factor may, for example, implicitly group personalization features with similar impact closer to each other. That is, features that have “a higher impact” have a higher similarity factor and are grouped closer together, while features that have “a lower impact” have a lower similarity factor and are grouped closer together.

In step 244, a personalization feature weight may be calculated for each of the plurality of personalization features. In various implementations, the personalization feature weight may, for example, provide an indication of a level of importance of a personalization feature to a field and a record containing the field. That is, a more important personalization feature will have a higher weight, while a less important personalization feature will have a lower weight. Of note, a personalization feature weight is an absolute value indicating importance of a feature and a similarity factor is a relative value indicating importance of a feature relative to other features.

In step 246, each personalization feature weight may be converted, for example, into a probability distribution.

In step 248, each similarity factor may be scaled, for example, based on the corresponding probability distribution. In one example, a personalization feature weight for a personalization feature may be converted to a probability distribution in step 246 and that probability distribution may be used to scale a similarity factor for the personalization feature in step 248.

In step 250, a most recently used affinity value may be generated for each of the plurality of personalization features.

In step 252, a ranking function may be generated. In various implementations, the ranking function may be based, for example, on the most recently used affinity values corresponding to each of the plurality of personalization features. The ranking function may be, for example, a function that reorders a list of input records for a given query. A goal of the ranking function may be, for example, to order records in decreasing order of relevance. In some implementations, relevance may be defined at a per user level (e.g., personalized relevance).

One or more parts of the above implementations may include software. Software is a general term whose meaning can range from part of the code and/or metadata of a single computer program to the entirety of multiple programs. A computer program (also referred to as a program) comprises code and optionally data. Code (sometimes referred to as computer program code or program code) comprises software instructions (also referred to as instructions). Instructions may be executed by hardware to perform operations. Executing software includes executing code, which includes executing instructions. The execution of a program to perform a task involves executing some or all of the instructions in that program.

An electronic device (also referred to as a device, computing device, computer, etc.) includes hardware and software. For example, an electronic device may include a set of one or more processors coupled to one or more machine-readable storage media (e.g., non-volatile memory such as magnetic disks, optical disks, read only memory (ROM), Flash memory, phase change memory, solid state drives (SSDs)) to store code and optionally data. For instance, an electronic device may include non-volatile memory (with slower read/write times) and volatile memory (e.g., dynamic random-access memory (DRAM), static random-access memory (SRAM)). Non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device has power removed, and that has sufficiently fast read/write times such that, rather than copying the part of the code to be executed into volatile memory, the code/data may be provided directly to the set of processors (e.g., loaded into a cache of the set of processors). In other words, this non-volatile memory operates as both long term storage and main memory, and thus the electronic device may have no or only a small amount of volatile memory for main memory.

In addition to storing code and/or data on machine-readable storage media, typical electronic devices can transmit and/or receive code and/or data over one or more machine-readable transmission media (also called a carrier) (e.g., electrical, optical, radio, acoustical or other forms of propagated signals—such as carrier waves, and/or infrared signals). For instance, typical electronic devices also include a set of one or more physical network interface(s) to establish network connections (to transmit and/or receive code and/or data using propagated signals) with other electronic devices. Thus, an electronic device may store and transmit (internally and/or with other electronic devices over a network) code and/or data with one or more machine-readable media (also referred to as computer-readable media).

Software instructions (also referred to as instructions) are capable of causing (also referred to as operable to cause and configurable to cause) a set of processors to perform operations when the instructions are executed by the set of processors. The phrase “capable of causing” (and synonyms mentioned above) includes various scenarios (or combinations thereof), such as instructions that are always executed versus instructions that may be executed. For example, instructions may be executed: 1) only in certain situations when the larger program is executed (e.g., a condition is fulfilled in the larger program; an event occurs such as a software or hardware interrupt, user input (e.g., a keystroke, a mouse-click, a voice command); a message is published, etc.); or 2) when the instructions are called by another program or part thereof (whether or not executed in the same or a different process, thread, lightweight thread, etc.). These scenarios may or may not require that a larger program, of which the instructions are a part, be currently configured to use those instructions (e.g., may or may not require that a user enables a feature, the feature or instructions be unlocked or enabled, the larger program is configured using data and the program's inherent functionality, etc.). As shown by these exemplary scenarios, “capable of causing” (and synonyms mentioned above) does not require “causing” but the mere capability to cause. While the term “instructions” may be used to refer to the instructions that when executed cause the performance of the operations described herein, the term may or may not also refer to other instructions that a program may include. Thus, instructions, code, program, and software are capable of causing operations when executed, whether the operations are always performed or sometimes performed (e.g., in the scenarios described previously). The phrase “the instructions when executed” refers to at least the instructions that when executed cause the performance of the operations described herein but may or may not refer to the execution of the other instructions.

Electronic devices are designed for and/or used for a variety of purposes, and different terms may reflect those purposes (e.g., user devices, network devices). Some user devices are designed to mainly be operated as servers (sometimes referred to as server devices), while others are designed to mainly be operated as clients (sometimes referred to as client devices, client computing devices, client computers, or end user devices; examples of which include desktops, workstations, laptops, personal digital assistants, smartphones, wearables, augmented reality (AR) devices, virtual reality (VR) devices, mixed reality (MR) devices, etc.). The software executed to operate a user device (typically a server device) as a server may be referred to as server software or server code), while the software executed to operate a user device (typically a client device) as a client may be referred to as client software or client code. A server provides one or more services (also referred to as serves) to one or more clients.

The term “user” refers to an entity (e.g., an individual person) that uses an electronic device. Software and/or services may use credentials to distinguish different accounts associated with the same and/or different users. Users can have one or more roles, such as administrator, programmer/developer, and end user roles. As an administrator, a user typically uses electronic devices to administer them for other users, and thus an administrator often works directly and/or indirectly with server devices and client devices.

FIG. 3A is a block diagram illustrating an electronic device 300 according to some example implementations. FIG. 3A includes hardware 320 comprising a set of one or more processor(s) 322, a set of one or more network interfaces 324 (wireless and/or wired), and machine-readable media 326 having stored therein software 328 (which includes instructions executable by the set of one or more processor(s) 322). The machine-readable media 326 may include non-transitory and/or transitory machine-readable media. Each of the previously described clients and the framework for modeling heterogeneous feature sets may be implemented in one or more electronic devices 300. In one implementation: 1) each of the clients is implemented in a separate one of the electronic devices 300 (e.g., in end user devices where the software 328 represents the software to implement clients to interface directly and/or indirectly with the framework for modeling heterogeneous feature sets (e.g., software 328 represents a web browser, a native client, a portal, a command-line interface, and/or an application programming interface (API) based upon protocols such as Simple Object Access Protocol (SOAP), Representational State Transfer (REST), etc.)); 2) the framework for modeling heterogeneous feature sets is implemented in a separate set of one or more of the electronic devices 300 (e.g., a set of one or more server devices where the software 328 represents the software to implement the framework for modeling heterogeneous feature sets); and 3) in operation, the electronic devices implementing the clients and the framework for modeling heterogeneous feature sets would be communicatively coupled (e.g., by a network) and would establish between them (or through one or more other layers and/or other services) connections for submitting requests to the framework for modeling heterogeneous feature sets and returning responses to the clients. Other configurations of electronic devices may be used in other implementations (e.g., an implementation in which the client and the framework for modeling heterogeneous feature sets are implemented on a single one of electronic device 300).

During operation, an instance of the software 328 (illustrated as instance 306 and referred to as a software instance; and in the more specific case of an application, as an application instance) is executed. In electronic devices that use compute virtualization, the set of one or more processor(s) 322 typically execute software to instantiate a virtualization layer 308 and one or more software container(s) 304A-304R (e.g., with operating system-level virtualization, the virtualization layer 308 may represent a container engine (such as Docker Engine by Docker, Inc. or rkt in Container Linux by Red Hat, Inc.) running on top of (or integrated into) an operating system, and it allows for the creation of multiple software containers 304A-304R (representing separate user space instances and also called virtualization engines, virtual private servers, or jails) that may each be used to execute a set of one or more applications; with full virtualization, the virtualization layer 308 represents a hypervisor (sometimes referred to as a virtual machine monitor (VMM)) or a hypervisor executing on top of a host operating system, and the software containers 304A-304R each represent a tightly isolated form of a software container called a virtual machine that is run by the hypervisor and may include a guest operating system; with para-virtualization, an operating system and/or application running with a virtual machine may be aware of the presence of virtualization for optimization purposes). Again, in electronic devices where compute virtualization is used, during operation, an instance of the software 328 is executed within the software container 304A on the virtualization layer 308. In electronic devices where compute virtualization is not used, the instance 306 on top of a host operating system is executed on the “bare metal” electronic device 300. The instantiation of the instance 306, as well as the virtualization layer 308 and software containers 304A-304R if implemented, are collectively referred to as software instance(s) 302.

Alternative implementations of an electronic device may have numerous variations from that described above. For example, customized hardware and/or accelerators might also be used in an electronic device.

FIG. 3B is a block diagram of a deployment environment according to some example implementations. A system 340 includes hardware (e.g., a set of one or more server devices) and software to provide service(s) 342, including the framework for modeling heterogeneous feature sets. In some implementations the system 340 is in one or more datacenter(s). These datacenter(s) may be: 1) first party datacenter(s), which are datacenter(s) owned and/or operated by the same entity that provides and/or operates some or all of the software that provides the service(s) 342; and/or 2) third-party datacenter(s), which are datacenter(s) owned and/or operated by one or more different entities than the entity that provides the service(s) 342 (e.g., the different entities may host some or all of the software provided and/or operated by the entity that provides the service(s) 342). For example, third-party datacenters may be owned and/or operated by entities providing public cloud services.

The system 340 is coupled to user devices 380A-380S over a network 382. The service(s) 342 may be on-demand services that are made available to one or more of the users 384A-384S working for one or more entities other than the entity which owns and/or operates the on-demand services (those users sometimes referred to as outside users) so that those entities need not be concerned with building and/or maintaining a system, but instead may make use of the service(s) 342 when needed (e.g., when needed by the users 384A-384S). The service(s) 342 may communicate with each other and/or with one or more of the user devices 380A-380S via one or more APIs (e.g., a REST API). In some implementations, the user devices 380A-380S are operated by users 384A-384S, and each may be operated as a client device and/or a server device. In some implementations, one or more of the user devices 380A-380S are separate ones of the electronic device 300 or include one or more features of the electronic device 300.

In some implementations, the system 340 is a multi-tenant system (also known as a multi-tenant architecture). The term multi-tenant system refers to a system in which various elements of hardware and/or software of the system may be shared by one or more tenants. A multi-tenant system may be operated by a first entity (sometimes referred to a multi-tenant system provider, operator, or vendor; or simply a provider, operator, or vendor) that provides one or more services to the tenants (in which case the tenants are customers of the operator and sometimes referred to as operator customers). A tenant includes a group of users who share a common access with specific privileges. The tenants may be different entities (e.g., different companies, different departments/divisions of a company, and/or other types of entities), and some or all of these entities may be vendors that sell or otherwise provide products and/or services to their customers (sometimes referred to as tenant customers). A multi-tenant system may allow each tenant to input tenant specific data for user management, tenant-specific functionality, configuration, customizations, non-functional properties, associated applications, etc. A tenant may have one or more roles relative to a system and/or service. For example, in the context of a customer relationship management (CRM) system or service, a tenant may be a vendor using the CRM system or service to manage information the tenant has regarding one or more customers of the vendor. As another example, in the context of Data as a Service (DAAS), one set of tenants may be vendors providing data and another set of tenants may be customers of different ones or all of the vendors' data. As another example, in the context of Platform as a Service (PAAS), one set of tenants may be third-party application developers providing applications/services and another set of tenants may be customers of different ones or all of the third-party application developers.

Multi-tenancy can be implemented in different ways. In some implementations, a multi-tenant architecture may include a single software instance (e.g., a single database instance) which is shared by multiple tenants; other implementations may include a single software instance (e.g., database instance) per tenant; yet other implementations may include a mixed model; e.g., a single software instance (e.g., an application instance) per tenant and another software instance (e.g., database instance) shared by multiple tenants.

In one implementation, the system 340 is a multi-tenant cloud computing architecture supporting multiple services, such as one or more of the following types of services: Customer relationship management (CRM); Configure, price, quote (CPQ); Business process modeling (BPM); Customer support; Marketing; Predictive Product Availability for Grocery Delivery; External data connectivity; Productivity; Database-as-a-Service; Data-as-a-Service (DAAS or DaaS); Platform-as-a-service (PAAS or PaaS); Infrastructure-as-a-Service (IAAS or IaaS) (e.g., virtual machines, servers, and/or storage); Analytics; Community; Internet-of-Things (IoT); Industry-specific; Artificial intelligence (AI); Application marketplace (“app store”); Data modeling; Security; and Identity and access management (IAM).

For example, system 340 may include an application platform 344 that enables PAAS for creating, managing, and executing one or more applications developed by the provider of the application platform 344, users accessing the system 340 via one or more of user devices 380A-380S, or third-party application developers accessing the system 340 via one or more of user devices 380A-380S.

In some implementations, one or more of the service(s) 342 may use one or more multi-tenant databases 346, as well as system data storage 350 for system data 352 accessible to system 340. In certain implementations, the system 340 includes a set of one or more servers that are running on server electronic devices and that are configured to handle requests for any authorized user associated with any tenant (there is no server affinity for a user and/or tenant to a specific server). The user devices 380A-380S communicate with the server(s) of system 340 to request and update tenant-level data and system-level data hosted by system 340, and in response the system 340 (e.g., one or more servers in system 340) automatically may generate one or more Structured Query Language (SQL) statements (e.g., one or more SQL queries) that are designed to access the desired information from the multi-tenant database(s) 346 and/or system data storage 350.

In some implementations, the service(s) 342 are implemented using virtual applications dynamically created at run time responsive to queries from the user devices 380A-380S and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code 360 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. Further, in one implementation, the application platform 344 includes an application setup mechanism that supports application developers' creation and management of applications, which may be saved as metadata by save routines. Invocations to such applications, including the framework for modeling heterogeneous feature sets, may be coded using Procedural Language/Structured Object Query Language (PL/SOQL) that provides a programming language style interface. Invocations to applications may be detected by one or more system processes, which manages retrieving application metadata for the tenant making the invocation and executing the metadata as an application in a software container (e.g., a virtual machine).

Network 382 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a 3rd Generation Partnership Project (3GPP) protocol, a 4th generation wireless protocol (4G) (e.g., the Long Term Evolution (LTE) standard, LTE Advanced, LTE Advanced Pro), a fifth generation wireless protocol (5G), and/or similar wired and/or wireless protocols, and may include one or more intermediary devices for routing data between the system 340 and the user devices 380A-380S.

Each user device 380A-380S (such as a desktop personal computer, workstation, laptop, Personal Digital Assistant (PDA), smartphone, smartwatch, wearable device, augmented reality (AR) device, virtual reality (VR) device, etc.) typically includes one or more user interface devices, such as a keyboard, a mouse, a trackball, a touch pad, a touch screen, a pen or the like, video or touch free user interfaces, for interacting with a graphical user interface (GUI) provided on a display (e.g., a monitor screen, a liquid crystal display (LCD), a head-up display, a head-mounted display, etc.) in conjunction with pages, forms, applications and other information provided by system 340. For example, the user interface device can be used to access data and applications hosted by system 340, and to perform searches on stored data, and otherwise allow one or more of users 384A-384S to interact with various GUI pages that may be presented to the one or more of users 384A-384S. User devices 380A-380S might communicate with system 340 using TCP/IP (Transfer Control Protocol and Internet Protocol) and, at a higher network level, use other networking protocols to communicate, such as Hypertext Transfer Protocol (HTTP), File Transfer Protocol (FTP), Andrew File System (AFS), Wireless Application Protocol (WAP), Network File System (NFS), an application program interface (API) based upon protocols such as Simple Object Access Protocol (SOAP), Representational State Transfer (REST), etc. In an example where HTTP is used, one or more user devices 380A-380S might include an HTTP client, commonly referred to as a “browser,” for sending and receiving HTTP messages to and from server(s) of system 340, thus allowing users 384A-384S of the user devices 380A-380S to access, process and view information, pages and applications available to it from system 340 over network 382.

In the above description, numerous specific details such as resource partitioning/sharing/duplication implementations, types and interrelationships of system components, and logic partitioning/integration choices are set forth in order to provide a more thorough understanding. The invention may be practiced without such specific details, however. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art would know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

The detailed description and claims may use the term “coupled,” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is exemplary and not limiting (e.g., alternative implementations may perform the operations in a different order, combine certain operations, perform certain operations in parallel, overlap performance of certain operations such that they are partially in parallel, etc.).

While the above description includes several example implementations, the invention is not limited to the implementations described and can be practiced with modification and alteration within the spirit and scope of the appended claims. The description is thus illustrative instead of limiting.

What is claimed is:

1. A computer-implemented method for modeling heterogeneous feature sets by a computerized information system, the method comprising:
generating a categorical embedding vector for each of a plurality of personalization features corresponding to a most recently used affinity, wherein each categorical embedding vector comprises a variable number of variably sized elements;
calculating a query-record based attention score for each of the plurality of personalization features, the query-record based attention score indicating a weight of the corresponding personalization feature;
converting each query-record based attention score to a corresponding probability distribution;
scaling each categorical embedding vector based on the corresponding probability distribution;
creating a fixed-dimensional personalization feature vector by aggregating the scaled categorical embedding vectors based on the probability distributions;
combining the fixed-dimensional personalization feature vector and a fixed-dimensional non-personalization feature vector to produce a fixed-dimensional query-record latent space feature vector; and
generating a ranking function based on the fixed-dimensional query-record latent space feature vector.

2. The computer-implemented method of claim 1, wherein calculating a query-record based attention score for each of the plurality of personalization features comprises:
multiplying the fixed-dimensional non-personalization feature vector by a weight matrix to produce a weighted fixed-dimensional non-personalization feature vector; and
for each of the categorical embedding vectors:
calculating a dot product of the weighted fixed-dimensional non-personalization feature vector and the categorical embedding vector to produce the corresponding query-record based attention score.

3. The computer-implemented method of claim 1, wherein the ranking function is selected from the group consisting of:
pointwise;
pairwise;
groupwise; and
set-wise.

4. The computer-implemented method of claim 1, wherein converting each query-record based attention score to a corresponding probability distribution comprises using a softmax activation function.

5. A non-transitory machine-readable storage medium that provides instructions that, if executed by a processor, are configurable to cause said processor to perform operations comprising:
generating a categorical embedding vector for each of a plurality of personalization features corresponding to a most recently used affinity, wherein each categorical embedding vector comprises a variable number of variably sized elements;
calculating a query-record based attention score for each of the plurality of personalization features, the query-record based attention score indicating a weight of the corresponding personalization feature;
converting each query-record based attention score to a corresponding probability distribution;
scaling each categorical embedding vector based on the corresponding probability distribution;
creating a fixed-dimensional personalization feature vector by aggregating the scaled categorical embedding vectors based on the probability distributions;
combining the fixed-dimensional personalization feature vector and a fixed-dimensional non-personalization feature vector to produce a fixed-dimensional query-record latent space feature vector; and
generating a ranking function based on the fixed-dimensional query-record latent space feature vector.

6. The non-transitory machine-readable storage medium of claim 5, wherein calculating a query-record based attention score for each of the plurality of personalization features comprises:
multiplying the fixed-dimensional non-personalization feature vector by a weight matrix to produce a weighted fixed-dimensional non-personalization feature vector; and
for each of the categorical embedding vectors:
calculating a dot product of the weighted fixed-dimensional non-personalization feature vector and the categorical embedding vector to produce the corresponding query-record based attention score.

7. The non-transitory machine-readable storage medium of claim 5, wherein the ranking function is selected from the group consisting of:
pointwise;
pairwise;
groupwise; and
set-wise.

8. The non-transitory machine-readable storage medium of claim 5, wherein converting each query-record based attention score to a corresponding probability distribution comprises using a softmax activation function.

9. An apparatus comprising:
a processor;
a non-transitory machine-readable storage medium that provides instructions that, if executed by the processor, are configurable to cause the apparatus to perform operations comprising:
generating a categorical embedding vector for each of a plurality of personalization features corresponding to a most recently used affinity, wherein each categorical embedding vector comprises a variable number of variably sized elements;
calculating a query-record based attention score for each of the plurality of personalization features, the query-record based attention score indicating a weight of the corresponding personalization feature;
converting each query-record based attention score to a corresponding probability distribution;
scaling each categorical embedding vector based on the corresponding probability distribution;
creating a fixed-dimensional personalization feature vector by aggregating the scaled categorical embedding vectors based on the probability distributions;
combining the fixed-dimensional personalization feature vector and a fixed-dimensional non-personalization feature vector to produce a fixed-dimensional query-record latent space feature vector; and
generating a ranking function based on the fixed-dimensional query-record latent space feature vector.

10. The apparatus of claim 9, wherein calculating a query-record based attention score for each of the plurality of personalization features comprises:
multiplying the fixed-dimensional non-personalization feature vector by a weight matrix to produce a weighted fixed-dimensional non-personalization feature vector; and
for each of the categorical embedding vectors:
calculating a dot product of the weighted fixed-dimensional non-personalization feature vector and the categorical embedding vector to produce the corresponding query-record based attention score.

11. The apparatus of claim 9, wherein the ranking function is selected from the group consisting of:
pointwise;
pairwise;
groupwise; and
set-wise.

12. The apparatus of claim 9, wherein converting each query-record based attention score to a corresponding probability distribution comprises using a softmax activation function.

13. A computer-implemented method for modeling heterogeneous feature sets by a computerized information system, the method comprising:
generating a similarity factor for each of a plurality of personalization features corresponding to a most recently used affinity;
calculating a personality feature weight for each of the plurality of personalization features;
converting each personality feature weight to a corresponding probability distribution;
scaling each similarity factor based on the corresponding probability distribution;
generating a most recently used affinity value for each of the plurality of personalization features; and
generating a ranking function based on the most recently used affinity values.
